(19) United States
(12) Patent Application Publication
(10) Pub. No.: US 2009/0096588 A1
(43) Pub. Date: Apr. 16, 2009

(54) Method Of Transmitting Product Information Read From An Identification Tag To A Processor And A System Therefor

(76) Inventor: Gerhard Stephanus Mynhardt, Sandton (ZA)

Correspondence Address: FROMMER LAWRENCE & HAUG, 745 FIFTH AVENUE- 10TH FL., NEW YORK, NY, 10151, US

(21) Appl. No.: 11/792,551

(22) PCT Filed: Dec. 8, 2005
(86) PCT No.: PCT/IB05/03704

§ 371 Date: Mar. 5, 2008

(30) Foreign Application Priority Data
Dec. 8, 2004 (ZA) 2004/9950

(51) Int. Cl. H04Q 5/22

(52) U.S. Cl. 340/10.42

(57) ABSTRACT

A method for transmitting product information read from an identification tag to another processor and a system therefore. The system finds one application in radio frequency (RFID) tags. The method includes receiving data read from a tag by a tag reader, the data including product data identifying the product to which the tag is attached and tag data uniquely identifying the tag and forwarding the product data but not the tag data to another processor. This ensures that the part of the tag number which specifically identifies the particular product is kept private. This invention has one application in a retail environment where products are tagged with RFID transponders.

### BACKGROUND OF THE INVENTION

THIS invention relates to a system and method of transmitting product information read from a tag, typically a radio frequency identification (RFID) tag, to another processor, and ensuring that the part of the tag number which specifically identifies the particular product is kept private. This invention has one application in a retail environment where products are tagged with RFID transponders.

Many consumers strongly object to the ability of the RFID transponders to be used to track consumer's movements, use of the products etc. The invention therefore provides a methodology to remove the ability to track RFID transponders down to an individual item level.

Consumers object to the possibility of linking personal details, such as that obtained from using a bankcard for payment, to the actual discrete unique item level code. A database can then be constructed linking the consumer name and details, the unique item number and the purchase details together. The RFID standards, which are being adapted internationally for use in retail environments, allow for a unique code per item. This in turn will allow RFID readers to track tagged items, such as clothing worn by the consumer, resulting effectively in tracking of the consumer.

However, RFID item level tagging is very useful for tracking items, merchandise and goods through the supply chain, and also for inventory management. This invention allows these functions, while removing the unique item level tracking capability when the product is sold.

This invention provides a method that addresses this need and the problems associated with it.

### SUMMARY OF THE INVENTION

According to the present invention there is provided a method of transmitting product information read from a radio frequency identification (RFID) tag to another processor, the method comprising:
receiving at a first processor data read from an RFID tag, the data including product data identifying the product to which the tag is attached and tag data uniquely identifying the tag; and
forwarding the product data but not the tag data to another processor.

The product data and tag data may be stored in a secure memory means associated with the first processor.

The first processor may be the processor of the RFID reader or the processor of an external module connected to the RFID reader.

### BRIEF DESCRIPTION OF THE DRAWINGS

FIG. 1 is a schematic block diagram of a system for implementing the method of the present invention according to a first embodiment;

FIG. 2 is a schematic block diagram of a system for implementing the method of the present invention according to a second embodiment;

FIG. 3 shows the typical layout of an EPC number as defined by EPCglobal™;

FIG. 4 shows an item level entry in a database with an RFID code along with the applicable industry standard product code that will be subsequently transmitted;

FIG. 5 shows a flow diagram of the operation of the privacy module according to the first embodiment; and

FIG. 6 shows a flow diagram of the operation of the privacy module according to the second embodiment.

### DESCRIPTION OF EMBODIMENTS

Referring to FIG. 1, a product 10 includes a tag attached thereto. The example embodiment will described with reference to the tag being a radio frequency identification (RFID) tag but it will be appreciated that other types of machine readable tags could be used.

The RFID tag is read using an antenna 12 associated with an RFID reader 14.

Where the RFID application is the attaching of RFID tags to products in a supermarket, for example, the data read by the RFID reader 14 is typically transmitted to a point of sale system 16.

As described above, because each RFID tag is uniquely identifiable and because the tag can be associated with a particular person when the person uses a credit card, for example, to pay for their purchased goods, there is a large amount of opposition to uniquely tagging goods.

However, in order to use the RFID technology each tag must necessarily be uniquely identified in order for the system to communicate with it.

In a first embodiment of the present invention, a privacy module 18 is implemented by altering the software being executed on a first processor (not shown) of the RFID reader 14.

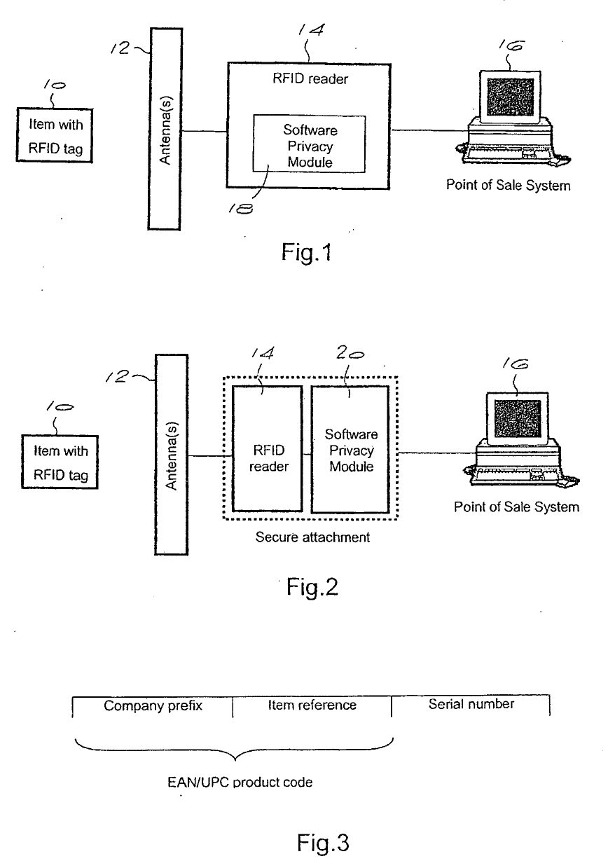

Alternatively, FIG. 2 illustrates a second embodiment to that of FIG. 1 with like reference numerals indicating like parts. However, in this embodiment, the privacy module is implemented in the form of a separate piece of hardware which connects to the RFID reader using a secure attachment. In this case, the software implementing the present invention will be executed on a first processor of the external module 20.

The privacy module hardware 20 is validated by the root firmware of the RFID reader before it can be used. The root firmware cannot be changed without noticeable damage to the privacy module and/or reader.

One method of connecting the RFID reader and the privacy module together may be that typical RFID readers 14 have serial ports for connecting external devices thereto and this serial port may be used to connect the software privacy module 20 to the RFID reader 14.

In either case, the privacy module will basically ensure that no code is transmitted to any external equipment where such code contains enough detail to allow unique item level tagging.

In order to achieve this objective, all codes will be converted by the module to industry standard product codes such as those defined by EAN™ International (www.ean-int.orq), retailer specific stock codes, such as retailer proprietary Stock Keeping Units (SKU) or any other code which does not contain a unique item level identifier.

This means that product type codes will be allowed, such as a specific brand and type of cereal for example, but no tagging at item level will be possible.

The methodology comprises receiving at the first processor data read from an RFID tag. Depending on the embodiment, the first processor will either be the processor of the RFID reader 14 or the processor of the external module 20.

The data received will include product data identifying the product to which the RFID tag is attached and tag data uniquely identifying the tag itself.

In practice, referring to FIG. 3, the product data will be the so-called company prefix and item reference of the numbering system as defined by EPCglobal™ (www.epcglobalinc.org). These are converted into the industry standard product codes.

In terms of the EPC numbering system, each RFID tag 10 includes both the industry standard product code and a serial number which uniquely identifies the individual tag.

In any event, the software privacy module 18 or 20 needs to maintain an inventory of tags that it is busy reading so that it can identify tags with the same industry standard product code or other product code, so this it can uniquely determine if the tag is the same as one already read, or if it is another tag with the same product code.

The privacy module may also emit an obfuscation code so that the user may identify the separate tags within a predetermined period. This is a random number associated with each item. A new random code for each item may be generated each time the reader is powered up. This would be used by applications that need to monitor a number of tags having the same product codes, but still maintaining the privacy of the serial numbers.

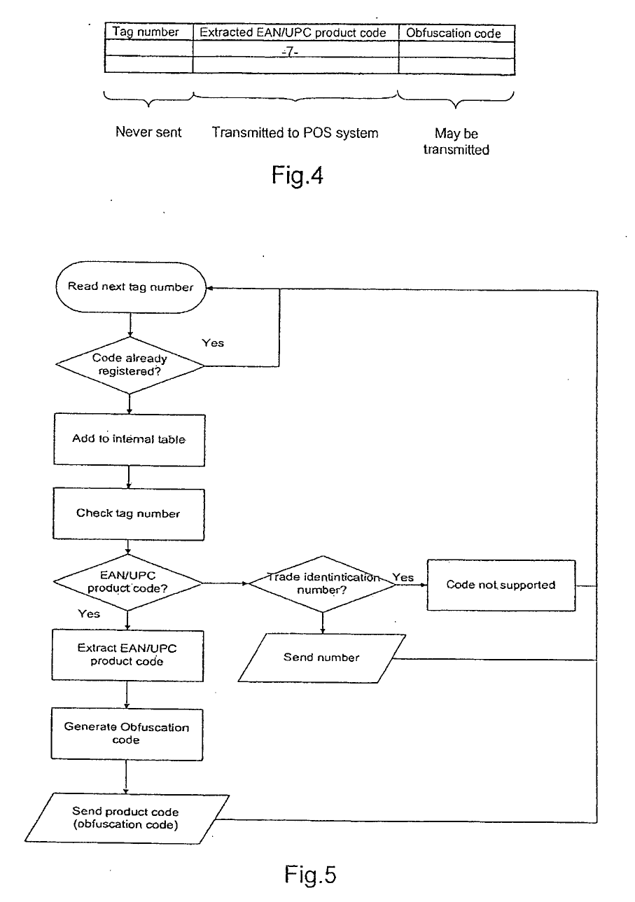

FIG. 4 shows an item level entry in a database, with an EPC code and EAN code which will subsequently be transmitted.

FIG. 5 illustrates the operation of the software privacy module of the first embodiment illustrated in FIG. 1.

Referring to the figure, for each tag that is read an entry is made into a tag table in a memory means associated with the processor of the RFID reader 14. A check is made of the type of tag. If the tag is an industry standard product code tag then the product code is extracted and stored in the tag table. An obfuscation code is also stored. The product code without the tag serial number is then sent to the point of sale (POS) system in the illustrated example of FIG. 1. It should be noted that therefore no unique identifier or serial number is sent to the POS system.

If the code read by the reader 14 is any other type of trade identification number, the number is stored in the tag table to facilitate reading of other tags but the number is not transmitted to the POS or other system. This allows non-standard or unsupported product codes to be kept private.

If the number is not a trade identification number, the tag is being used to track an asset or other object, and is not being used in the retail trade. In this case the entire number is transmitted to the connected system, as there is no need to hide the serial number of tags that are not being used as a trade identification number.

The EPC specifications indicate which ranges of codes are used for trade identification numbers.

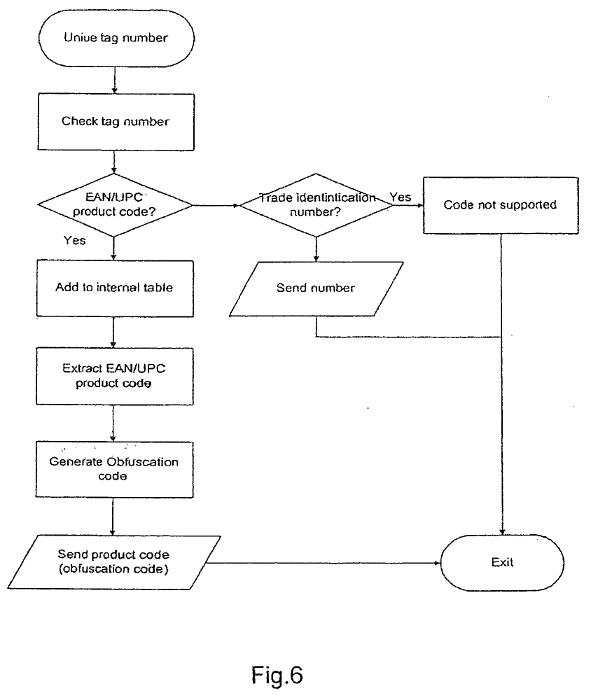

FIG. 6 shows the flow diagram of the operation of the software in the second embodiment illustrated in FIG. 2. In this embodiment the privacy module 20 sits between a standard RFID reader 14 and the connected POS or other host system 16. The module will only be activated once the RFID reader 14 has read a tag.

The tag number is checked. If it is an industry standard product code, the number is added to the internal tag table and an obfuscation code is generated. The product code and the obfuscation code, if required, are sent to the connected POS or host system 16 and then the module waits for the next tag number.

If the code is any other type of trade identification number, the number is ignored and the number is not transmitted to the POS or other system. The module waits for the next tag number.

If the number is not a trade identification number, the tag is being used to track an asset or other object. In this case the entire number is transmitted to the connected system. The module then waits for the next tag number.

Thus, the privacy module is able to protect the privacy of the consumer.

Additionally, the software can cause the ‘kill’ function to be performed on any sold items. Once the ‘kill’ function is performed no device can read the tag and the tag can no longer be tracked. In general, RFID tags have a standard feature that allows the tag to be “killed” and rendered inoperative. This invention allows the testing to ensure that a tag has been killed, before allowing the serial number of tag to be exposed. Once the tag has been “killed” it can no longer be read and there is no cause to keep the serial number secret.

The privacy module can certify that a tag has been killed by re-reading a tag and verifying its killed status. Once the tag has been verified as being killed the original item code can be reported for stock management.

The ‘killed’ status may optionally be displayed.

A secure accumulator may also optionally be provided to show the number of item's scanned and ‘killed’.

The security of the privacy module includes the following:
Removal of the unique item number so that only the industry standard product code is available in a similar fashion as the current printed barcodes.
Unique item number may be replaced by obfuscation code so that multiple items with the same industry standard product code may be tracked.
Duplicate ranges on RFID side, single industry standard product code on other side.
Lists of tag numbers are retained for a maximum period of typically two hours. The list is required to be able to accommodate multiple items with the same industry standard product code.
Each time the Privacy Module is powered up, a new table of tags will be created. When power is removed, these lists are erased.
Tags that have been verified as killed may have their unique numbers revealed.
No application software can be loaded into the privacy module to extract information.

1. A system for transmitting product information read from an identification tag to another processor, the system including:
a tag reader; and
a first processor for receiving data read from a tag by the tag reader, the data including product data identifying the product to which the tag is attached and tag data uniquely identifying the tag and for forwarding the product data but not the tag data to another processor.

2. The system of claim 1 wherein the tag is a radio frequency tag and the reader is a radio frequency tag (RFID) reader.

3. The system of claim 1 further including secure memory means wherein the product data and tag data are stored in the secure memory means associated with the first processor.

4. The system of claim 1 wherein the first processor is the processor of the tag reader or the processor of an external module connected to the tag reader.

5. The system of claim 1 wherein the product data includes one or more of a retailer specific stock code, a specific brand code and a specific product type code.

6. The system of claim 1 wherein the first processor further generates a unique obfuscation code for a scanned item and forwards the obfuscation code together with the product data to the other processor.

7. The system of claim 6 wherein the first processor further stores the obfuscation code in a memory means.

8. The system of claim 1 wherein the first processor further:
checks to see if a tag has been killed; and
if the tag has been killed, releases the tag data.

9. The system of claim 1 wherein the first processor further retains at least one of the stored tag data, product data and obfuscation code for a period of time and then deletes the stored data.

10. The system of claim 1 wherein the stored data is erased when power is removed from the first processor.

11. A method of transmitting product information read from an identification tag to another processor, the method including:
receiving at a first processor data read from a tag, the data including product data identifying the product to which the tag is attached and tag data uniquely identifying the tag; and
forwarding the product data but not the tag data to another processor.

12. The method of claim 11 wherein the tag is a radio frequency tag.

13. The method of claim 11 wherein the product data and tag data are stored in a secure memory means.

14. The method of claim 11 wherein the first processor is the processor of the tag reader or the processor of an external module connected to the tag reader.

15. The method of claim 11 wherein the product data includes one or more of a retailer specific stock code, a specific brand code and a specific product type code.

16. The method of claim 11 further including generating a unique obfuscation code for a scanned item and forwarding the obfuscation code together with the product data to the other processor.

17. The method of claim 16 further including storing of the obfuscation code in a memory means.
